(19) United States
(12) Patent Application Publication
(10) Pub. No.: US 2025/0357616 A1
(43) Pub. Date: Nov. 20, 2025

(54) VEHICLE LOWER PORTION STRUCTURE

(71) Applicant: TOYOTA JIDOSHA KABUSHIKI KAISHA, Aichi-ken (JP)

(72) Inventors: Shigeyuki INOUE, Toyota-shi (JP); Kazuki SUGIE, Miyoshi-shi (JP); Yuki TAKAHASHI, Miyoshi-shi (JP)

(21) Appl. No.: 19/098,992

(22) Filed: Apr. 3, 2025

(30) Foreign Application Priority Data
May 20, 2024 (JP) 2024-081508

(51) Int. Cl. H01M 50/325; H01M 50/249; H01M 50/271

(52) U.S. Cl. CPC H01M 50/325; H01M 50/249; H01M 50/271; H01M 2220/20

(57) ABSTRACT

A vehicle lower portion structure includes: a power storage device including at least one power storage stack, a case that houses the at least one power storage stack, and a pressure release valve provided on a top surface of the case; a cable provided above the power storage device; and a cover provided between the pressure release valve and the cable.

### CROSS-REFERENCE TO RELATED APPLICATION

This application claims priority to Japanese Patent Application No. 2024-081508 filed on May 20, 2024, incorporated herein by reference in its entirety.

### BACKGROUND

### 1. Technical Field

The disclosure relates to a vehicle lower portion structure.

### 2. Description of Related Art

For example, Japanese Unexamined Patent Application Publication (Translation of PCT Application) No. 2022-516519 (JP 2022-516519 A) discloses a power battery pack including: a plurality of unit cells; a battery tray that houses the unit cells; and a cover plate connected to the battery tray. A battery pack explosion-proof valve attached to an exhaust hole is mounted to a side wall of the battery tray.

### SUMMARY

In the power battery pack disclosed in JP 2022-516519 A, a cable may be installed near the battery pack explosion-proof valve. In this case, when gas is discharged from a unit cell, there is a concern that the gas discharged from the battery pack explosion-proof valve may come into contact with the cable and damage the cable.

The purpose of the present disclosure is to provide a vehicle lower portion structure capable of preventing gas discharged from a pressure release valve from coming into contact with a cable, and preventing resulting damage to the cable.

A vehicle lower portion structure according to one aspect of the present disclosure includes: a power storage device including at least one power storage stack, a case that houses the at least one power storage stack, and a pressure release valve provided on a top surface of the case; a cable provided above the power storage device; and a cover provided between the pressure release valve and the cable.

According to the present disclosure, it is possible to provide the vehicle lower portion structure capable of preventing the gas discharged from the pressure release valve from coming into contact with the cable, and preventing resulting damage to the cable.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view schematically showing a vehicle including vehicle lower portion structure according to an embodiment of the present disclosure;

FIG. 2 is a perspective view schematically showing a power storage device;

FIG. 3 is a perspective view schematically showing a state in which the vehicle lower portion structure is viewed from below;

FIG. 4 is a sectional view schematically showing the vehicle lower portion structure; and

FIG. 5 is a sectional view along the V-V line in FIG. 4.

### DETAILED DESCRIPTION OF EMBODIMENTS

An embodiment of the present disclosure will be described with reference to the drawings. Note that, in the drawings to be referenced hereinafter, the same or equivalent members are labeled with the same numbers.

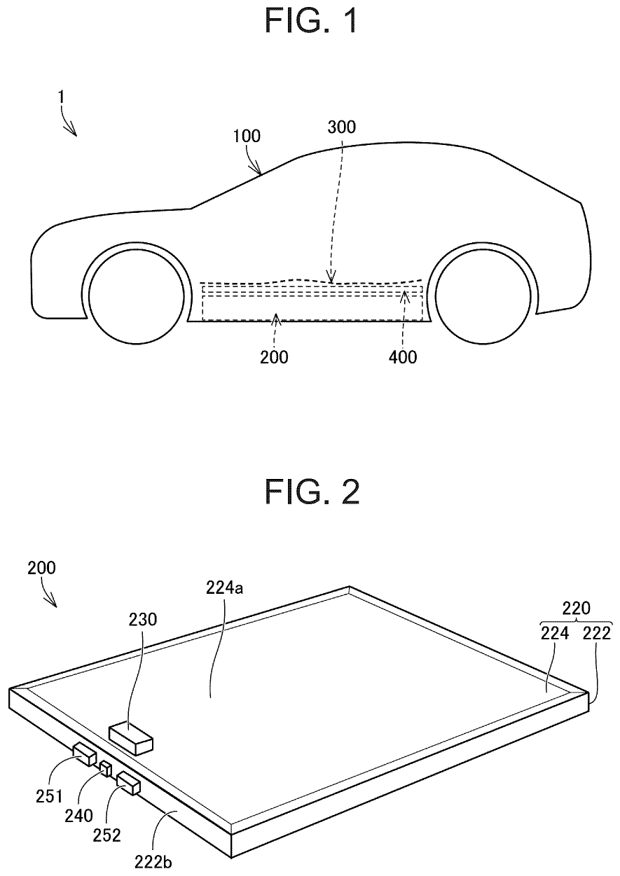

As shown in FIG. 1 to FIG. 5, a vehicle 1 including a vehicle lower portion structure has a vehicle body 100, a power storage device 200, a cable 300, and a cover 400.

The vehicle body 100 has a mount portion 110 and a recessed portion 120.

The mount portion 110 is a portion to which the power storage device 200 is mounted. The mount portion 110 is constituted by a lower portion of the vehicle body 100.

The recessed portion 120 has a recessed shape recessed upward from the mount portion 110. The recessed portion 120 extends in the front-rear direction of the vehicle. The recessed portion 120 may be formed in a central portion in the width direction of the vehicle.

The power storage device 200 is mounted to the mount portion 110 of the vehicle body 100. The power storage device 200 has at least one power storage stack 210, a case 220, a pressure release valve 230, and a breathing membrane 240.

At least one power storage stack 210 includes a plurality of (for example, four) power storage stacks 210. Each of the power storage stacks 210 includes a plurality of power storage cells 211 (see FIG. 4). The power storage cells 211 are disposed, for example, in a line along the front-rear direction of the vehicle. Note that the power storage cells 211 may be disposed in a line along the width direction of the vehicle.

Each power storage cell 211 is formed in a flat rectangular parallelepiped shape. Examples of the power storage cells 211 include lithium ion batteries. Each power storage cell 211 may be constituted by an all-solid-state battery using a solid electrolyte. Each power storage cell 211 may include a safety valve that is provided at a position facing an upper cover 224, namely on the top surface of a housing of the power storage cell 211.

The case 220 houses the power storage stacks 210. The case 220 may house a junction box or the like. The case 220 includes a lower case 222 and an upper cover 224.

The lower case 222 is open upward. The lower case 222 has a bottom wall 222a and a peripheral wall 222b.

The bottom wall 222a supports each of the power storage stacks 210.

The peripheral wall 222b rises from a peripheral edge of the bottom wall 222a. The peripheral wall 222b surrounds the periphery of the power storage stacks 210. The peripheral wall 222b is formed in a substantially quadrangular cylindrical shape. A positive electrode connector 251 and a negative electrode connector 252 are provided on a side surface of the peripheral wall 222b.

The upper cover 224 houses the power storage stacks 210 together with the lower case 222. A peripheral edge of the upper cover 224 is fixed to a top end portion of the peripheral wall 222b with a bolt or the like. The upper cover 224 has a top surface 224a.

The pressure release valve 230 is provided on the top surface 224a of the case 220. The pressure release valve 230 releases the pressure in the case 220. The pressure release valve 230 opens when the pressure in the case 220 is equal to or greater than a reference value. The pressure release valve 230 is constituted by a check valve.

The breathing membrane 240 is provided on a side surface, that is, the peripheral wall 222b of the case 220. Specifically, a through-hole is provided in the peripheral wall 222b, and the breathing membrane 240 is attached to the peripheral wall 222b so as to cover the through-hole. The breathing membrane 240 regulates the pressure in the case 220 by allowing passage of gas between the inside of the case 220 and the outside of the case 220. As shown in FIG. 4, the breathing membrane 240 is provided on a side surface of the peripheral wall 222b on the front side of the vehicle. The breathing membrane 240 is disposed between the positive electrode connector 251 and the negative electrode connector 252.

The cable 300 is provided above the power storage device 200. The cable 300 connects devices including the power storage cells 211 to each other. The cable 300 includes a high-voltage cable 310. The cable 300 is disposed (routed) in the recessed portion 120 of the vehicle body 100.

The cover 400 is provided between the power storage device 200 and the cable 300. The cover 400 is made of metal or the like. The cover 400 has an interposed portion 410 and a restriction portion 420.

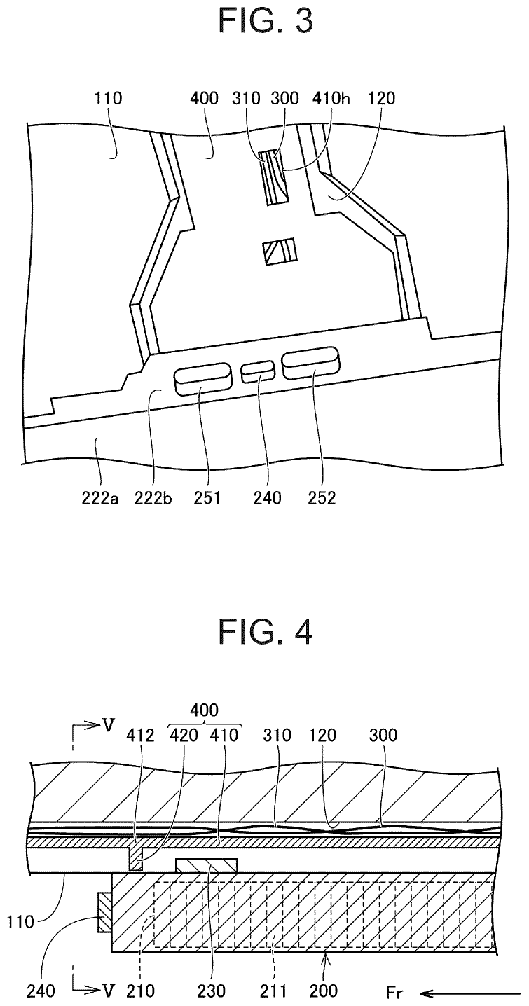

The interposed portion 410 is interposed between the pressure release valve 230 and the cable 300. The interposed portion 410 is disposed in the recessed portion 120. The interposed portion 410 may be formed in a flat plate shape. The interposed portion 410 supports the cable 300. As shown in FIG. 3, in the interposed portion 410, an exposure opening 410h through which a portion of the cable 300 is exposed downward may be formed.

As shown in FIG. 4, the interposed portion 410 has a middle portion 412 located between a portion located above the pressure release valve 230 and a portion located above the breathing membrane 240. The middle portion 412 overlaps the top surface 224a of the upper cover 224 in the up-down direction.

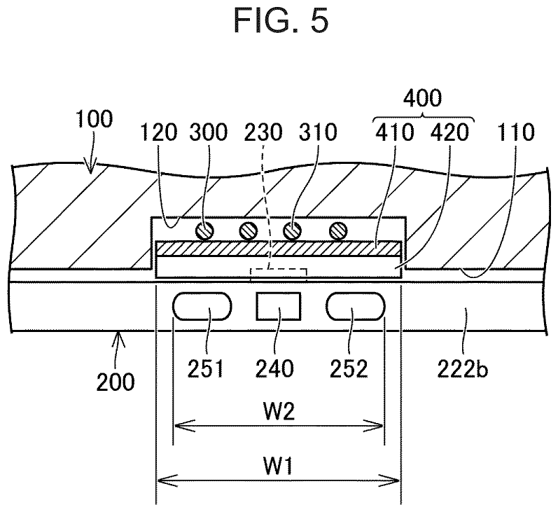

The restriction portion 420 restricts the gas discharged from the pressure release valve 230 from flowing toward the breathing membrane 240. As shown in FIG. 4, the restriction portion 420 has a shape extending downward from the middle portion 412. As shown in FIG. 5, a length W1 of the restriction portion 420 in the width direction of the vehicle is greater than a length W2 between the outer end of the positive electrode connector 251 and the outer end of the negative electrode connector 252 in the width direction of the vehicle.

As described above, in the vehicle lower portion structure of the present embodiment, since the cover 400 is provided between the pressure release valve 230 and the cable 300, the gas discharged from the pressure release valve 230 is prevented from coming into contact with the cable 300, and resulting damage to the cable 300 is prevented.

Moreover, since the length W1 is greater than the length W2, the gas discharged from the pressure release valve 230 is prevented from coming into contact with the electrode connectors 251, 252.

Those skilled in the art will appreciate that the exemplary embodiment described above is a specific example of the following aspects.

### Aspect 1

A vehicle lower portion structure including:
a power storage device including at least one power storage stack, a case that houses the at least one power storage stack, and a pressure release valve provided on a top surface of the case;
a cable provided above the power storage device; and
a cover provided between the pressure release valve and the cable.

In this vehicle lower portion structure, since the cover is provided between the pressure release valve and the cable, gas discharged from the pressure release valve is prevented from coming into contact with the cable, and resulting damage to the cable is prevented.

### Aspect 2

The vehicle lower portion structure according to aspect 1, wherein
the power storage device further includes a breathing membrane provided on a side surface of the case, and
the cover has
   an interposed portion interposed between the pressure release valve and the cable, and
   a restriction portion that restricts gas discharged from the pressure release valve from flowing toward the breathing membrane.

In this aspect, the gas discharged from the pressure release valve is prevented from coming into contact with the breathing membrane, and resulting damage to the breathing membrane is prevented.

### Aspect 3

The vehicle lower portion structure according to aspect 2, wherein
the interposed portion has a middle portion located between a portion located above the pressure release valve and a portion located above the breathing membrane, and
the restriction portion has a shape extending downward from the middle portion.

In this aspect, the restriction portion effectively blocks the gas flowing from the pressure release valve toward the breathing membrane.

### Aspect 4

The vehicle lower portion structure according to aspect 2 or 3, further including a vehicle body, wherein
the power storage device is mounted to a lower portion of the vehicle body,
the vehicle body includes
   a mount portion to which the power storage device is mounted, and
   a recessed portion having a recessed shape recessed upward from the mount portion, and
the cable and the interposed portion are disposed in the recessed portion.

### Aspect 5

The vehicle lower portion structure according to any one of aspects 1 to 4, wherein the cable includes a high-voltage cable.

Note that the embodiment disclosed herein is to be considered as exemplary and not restrictive in all respects. The scope of the disclosure is defined by the claims rather than the description of the embodiment, and further includes all modifications within the meaning and range equivalent to the claims.

What is claimed is:

1. A vehicle lower portion structure comprising:
a power storage device including
at least one power storage stack,
a case that houses the at least one power storage stack, and
a pressure release valve provided on a top surface of the case;
a cable provided above the power storage device; and
a cover provided between the pressure release valve and the cable.

2. The vehicle lower portion structure according to claim 1, wherein
the power storage device further includes a breathing membrane provided on a side surface of the case, and
the cover has
an interposed portion interposed between the pressure release valve and the cable, and
a restriction portion that restricts gas discharged from the pressure release valve from flowing toward the breathing membrane.

3. The vehicle lower portion structure according to claim 2, wherein
the interposed portion has a middle portion located between a portion located above the pressure release valve and a portion located above the breathing membrane, and
the restriction portion has a shape extending downward from the middle portion.

4. The vehicle lower portion structure according to claim 2, further comprising a vehicle body, wherein
the power storage device is mounted to a lower portion of the vehicle body,
the vehicle body includes
a mount portion to which the power storage device is mounted, and
a recessed portion having a recessed shape recessed upward from the mount portion, and
the cable and the interposed portion are disposed in the recessed portion.

5. The vehicle lower portion structure according to claim 1, wherein the cable includes a high-voltage cable.
